(19) United States
(12) Patent Application Publication
(10) Pub. No.: US 2005/0182615 A1
(43) Pub. Date: Aug. 18, 2005

(54) Method and system for creating an automatically adjusting USB mass storage device

(75) Inventor: Eric Richard Kern, Durham, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 10/777,385

(22) Filed: Feb. 12, 2004

(51) Int. Cl. G06F 9/455

(52) U.S. Cl. 703/24

(57) ABSTRACT

A method and system for virtually mounting Mass Storage Devices (MSDs) that correspond to physically mounted MSDs remotely booting a server from a client administrator using a dynamically configured mass storage device emulator. One or more Mass Storage Devices (MSDs) are mounted on an administrative computer, according to how many MSDs are required by a remote computer. The MSDs are coupled to a Storage Device Emulator (SDE) via a hyper-secure network. The remote computer then boots up using the SDE, which obtains packet data emulating the MSDs.

### BACKGROUND OF THE INVENTION

1. Technical Field

This invention relates generally to network computing systems, and in particular to remotely managed computers. Still more particularly, the present invention relates to a method and system for dynamically configuring a Universal Serial Bus (USB) device interface to flexibly make available, to a remotely managed computer, mass storage devices that are mounted on a server.

2. Description of the Related Art

While early computers were “stand alone” and unable to communicate with other computers, most computers today are able to communicate with other computers for a variety of purposes, including sharing data, e-mailing, downloading programs, coordinating operations, etc. Each computer typically connects to a network via a Network Interface Card (NIC) or an integrated Local Area Network (LAN) On Motherboard (LOM). The network couples multiple computers and/or peripheral devices (such as printers, secondary storage, etc.) The network may be a Local Area Network (LAN) or a Wide Area Network (WAN).

A LAN is a small local network, wired or wireless, that is typically used by a single enterprise. Such LANs, using architectures such, as an Ethernet, Token Ring, ARCnet or a wireless protocol such as 802.11a/b/g, are used to connect computers and peripheral devices within a limited area, such as a single campus or building.

Computers are not limited to the confines of a LAN. Rather, a computer can be connected to another computer or peripheral device via a wide area network (WAN), such as the Internet, to provide a communications link over a larger area. Each computer can be directly connected to a WAN via a Network Interface Card (NIC) or LOM, or the computer can be indirectly connected to the WAN via the LAN. The WAN can be wired or wireless, similar to that described for the LAN.

One advantage of a network based computer system is that resources, including peripherals such as hard drives, printers, etc., can be shared on the network. A typical way of sharing such resources is to assign an Internet Protocol (IP) address to each peripheral, and authorize certain computers on the network to access that peripheral. However, such a system requires extensive command and control resources to avoid corruption and cross talk of the resource, especially if the resource is a storage device.

What is needed, therefore, is a method and system for a remote computer to utilize a remote mass storage device without the need for cumbersome IP addresses, etc. Preferably, such a system would be dynamically flexible, so that different numbers of drives can be emulated by the remote computer according to its needs.

### SUMMARY OF THE INVENTION

As will be seen, the foregoing invention satisfies the foregoing needs and accomplishes additional objectives. Briefly described, the present invention provides a method and system for virtually mounting Mass Storage Devices (MSDs) that correspond to physically mounted MSDs that are remotely mounted on an administrative computer.

A user mounts multiple drives on an administrative computer, according to how many drives will be needed by a client bootable computer. A signal is sent to a Universal Serial Bus (USB) Mass Storage Device Interface (MSDI) on the client computer, indicating how many MSDs are mounted and available on the administrative computer. The USB MSDI signals a USB Emulated Storage Device (ESD) on the client computer to disconnect from the client computer while the USB MSDI reconfigures to show the appropriately set maximum Logic Unit Number (LUN) corresponding with the multiple MSDs mounted on the administrative computer. The USB ESD then reconnects as a new USB device that has morphed appropriately to show the correct MSDs. The Operating System (OS) or Basic Input/Output System (BIOS) on the client computer sees the new USB device and adds the MSDs to a list of drives connected to the system. The MSDs mounted on the administrative computer are now used by the client computer as if the MDSs were connected directly to the client computer.

### BRIEF DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1 depicts a schematic diagram illustrating a computer network within which the present invention may find application;

FIG. 2 depicts an exemplary bootable computer under boot control of an administrative computer;

FIG. 3 illustrates an exemplary administrative server; and

FIG. 4 is a flow-chart of steps taken in a preferred embodiment of the present invention for virtually mounting mass storage devices on the bootable computer.

### DETAILED DESCRIPTION OF THE PREFERRED EMBODIMENT

Referring now to the drawing figures, in which like numerals indicate like elements or steps throughout the several views, a preferred embodiment of the present invention will be described. In general, the present invention provides an improved method and system for emulating mass storage devices.

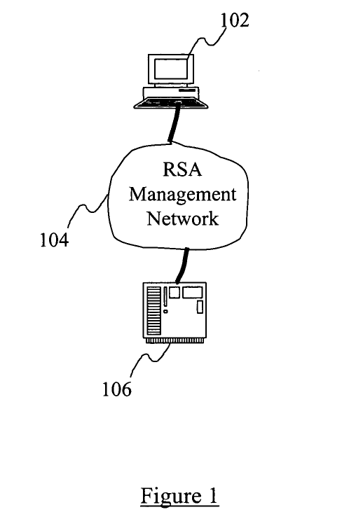

With reference now to FIG. 1, there is depicted an exemplary diagram of an administrative computer 102 coupled to a hyper-secure Remote Supervisor Adapter (RSA) management network 104, which is coupled to a bootable computer 106. Bootable computer 106 is preferably a network server that, when booting up or re-booting, is under the control of administrative computer 102. Thus, the logical relationship between administrative computer 102 and bootable computer 106 is not unlike that of a server and client on a network. Additional details of administrative computer 102 and bootable computer 106 are given below.

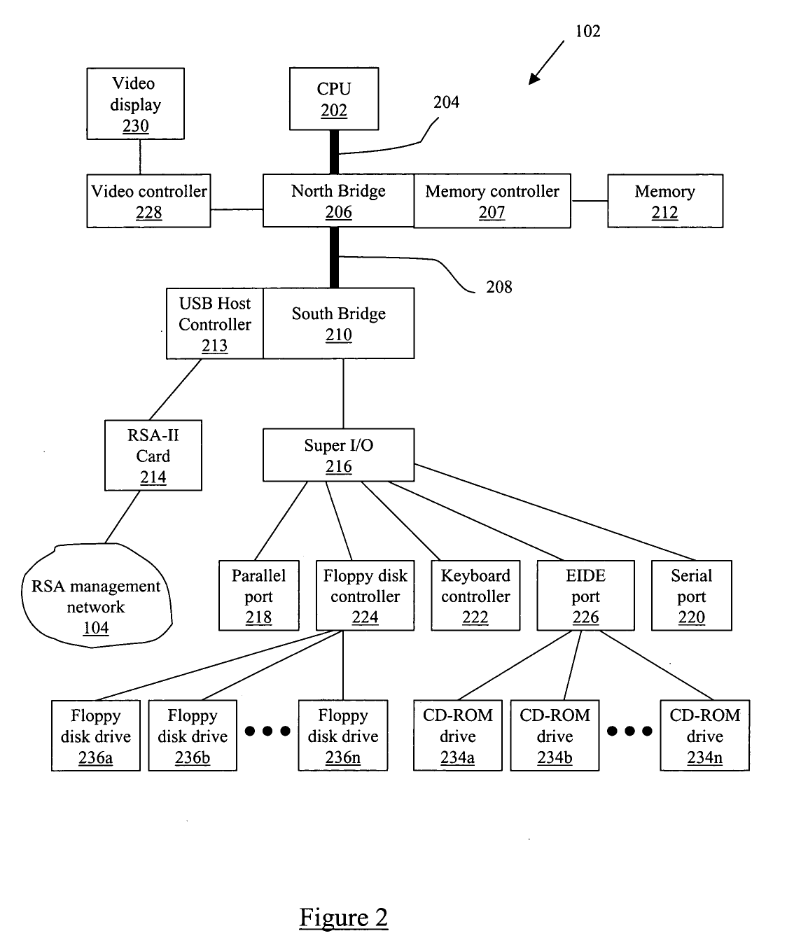

With reference now to FIG. 2, additional detail of administrative computer 102 is given. A Central Processing Unit (CPU) 202 connects via a processor interface bus 204 (also referred to in the art as a “front side bus,” “host bus,” or “system bus”) to a North Bridge 206. North Bridge 206 is a chip or chipset arbiter logic circuit having a memory controller 207 connected to a system memory 212. A video controller 228 is coupled to North Bridge 206 and a video display 230 for viewing a graphical user interface of software operations being performed on administrative computer 102 or remote operations, including booting operations, being performed on remote bootable computer 106. Also connected to North Bridge 206 is a high speed interconnect bus 208. North Bridge 206 is connected via interconnect bus 208, which may be a Peripheral Component Interconnect (PCI) bus, to a South Bridge 210.

South Bridge 210 is a chip or chipset Input/Output (I/O) arbiter that includes the necessary interface logic to convey signals from interconnect bus 208 to (typically slower) I/O interfaces, including a Super I/O 216. Super I/O 216 is preferably a chip or chipset including necessary logic and interfaces for a parallel port 218 and a non-USB (Universal Serial Bus) serial port 220, as are understood in the art of computer architecture. Super I/O 216 may also include controllers for non-USB devices such as a keyboard controller 222 for a non-USB keyboard and an Enhanced Integrated Device Electronics (EIDE) port 226, to which is connected an array of Compact Disk—Read Only Memory (CD-ROM) drives 234a-n. Also connected to Super I/O 216 is a floppy disk controller 224. Floppy disk controller 224 supports an interface with one or more floppy disk drives 236, depicted in exemplary form as an array of floppy drives 236a-n.

Coupled with South Bridge 210 is a USB host controller 213, which provides a USB interface from USB compliant devices (not shown) to administrative computer 102, including CPU 202. USB compliant devices may be floppy disk drives, CD-ROM drives, keyboards and other peripheral devices that are configured to comply with the “Universal Serial Bus Specification” release 2.0, Apr. 27, 2000 (USB.org), which release or later is herein incorporated by reference in its entirety. USB host controller 213, which is likewise USB compliant, may be implemented in a combination of hardware, firmware and/or software.

As known to those skilled in the art of computer peripheral device interfaces, the USB specification was prepared by representatives of Compaq Computer Corporation, Hewlett-Packard Company, Intel Corporation, Lucent Technologies Inc., Microsoft Corporation, NEC Corporation, and Royal Philips Electronics (Philips). Peripheral device interfaces that comply with the specification are referred to as USB interfaces and have been included in many recently developed personal computer systems. Such USB devices are generally referenced as either low-speed devices, capable of transferring data at a rate of 1.5 Megabits per second (Mb/s); or high-speed devices (also called full-speed devices) capable of transferring data at 12 Mb/s. Under the USB 2.0 specification, full-speed devices are capable of using 40× multipliers for a transfer rate of 480 Mb/s, and such USB devices are typically known as high-speed devices.

Within a computer system, a USB interface serves to provide well-known plug-n-play capability for computer peripherals such as external Compact Disc—Read Only Memory (CD-ROM) drives, joysticks, magnetic tape and floppy drives, external hard drives, scanners, and printers. Additionally, the USB interface allows an alternate connection for primary system input devices such as keyboards and mice, providing an alternative to the dedicated keyboard and mouse non-USB ports that many personal computer manufacturers provide. The industry generally refers to the non-USB keyboard and mouse ports as the PS/2 keyboard and PS/2 mouse port, respectively.

Coupled to USB Host controller 213 is a Remote Supervisor Adapter (RSA) card 214, preferably an RSA-II or later version card manufactured by International Business Machines of Armonk, N.Y. RSA card 214 provides a connection to hyper-secure RSA management network 104 using security methodology known to those skilled in the art of network, and particularly RSA network, security. As described in further detail below, RSA card 214 communicates network packets of information in a hyper-secure manner between administrative computer 102 and bootable computer 106.

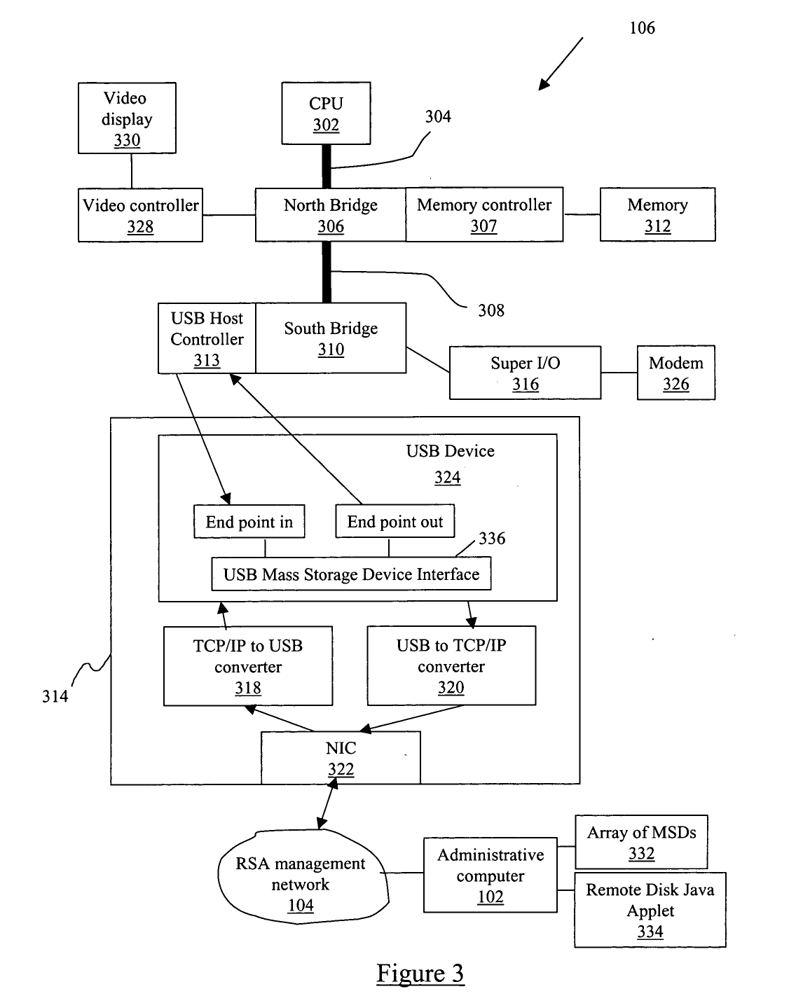

With reference now to FIG. 3, there is depicted a block diagram of an exemplary bootable computer 106. A Central Processing Unit (CPU) 302 connects via a processor interface bus 304 (also referred to in the art as a “front side bus,” “host bus,” or “system bus”) to a North Bridge 306. North Bridge 306 has a memory controller 307 connected to a system memory 312. Also connected to North Bridge 306 is a high speed interconnect bus 308. Also connected to North Bridge 306 is a video controller 328, which drives a video display 330.

When bootable computer 106 is being remotely booted up, as described below, the booting process and progress can be visually monitored by an administrator at administrative computer 102. This remote visual monitoring can be performed using a video feed, either direct or through a video camera, from video display 330 of bootable computer 106 to video display 230 of administrative computer 102. North Bridge 306 is connected via interconnect bus 308, which may be a Peripheral Component Interconnect (PCI) bus, to a South Bridge 310.

South Bridge 310 includes the necessary interface logic to convey signals from interconnect bus 308 to a Super I/O 316. Connected to Super I/O 316 is a modulator/demodulator (modem) 326, which modulates signals for transmission on telephone and telephone like lines (not shown).

Coupled with South Bridge 310 is a USB host controller 313, which provides a USB interface from a USB-Storage Device Emulator (USB-SDE) 314. USB host controller 313 communicates with USB-SDE 314 as though USB-SDE 314 were a physical USB device(s). That is, USB-SDE 314 provides multiple emulated mass storage devices, such as a CD-ROM, a floppy drive, a ZIP drive, etc. USB host controller 313 communicates with end points “in” and “out,” which communicate with a USB Mass Storage Device Interface (USB-MSDI) 336.

A USB device 324 includes a USB Mass Storage Device Interface (USB-MSDI) 336, which provides an interfaces that emulates of an array of MSDs 332 that have been mounted on administrative computer 120. Emulation data (including Logical Unit Numbers (LUN) identifying a particular physical remote MSD as well as data on that physical remote MSD) is received via a Network Interface Card (NIC) 322, which receives network packets from RSA management network 104. The packets are in TCP/IP format, and must be “unwrapped” by a TCP/IP to USB converter 318, before the data is sent to USB-MSDI 336.

Similarly, USB signals sent from USB host controller 313 to USB device 324 must first be converted into TCP/IP format before being sent to administrative computer 102. To accomplish this, the USB signal is passed through a USB to TCP/IP converter 320, which “wraps” the USB data in a TCP/IP packet for transmission to administrative computer 102.

Note that administrative computer 102 has an array of previously mounted MSDs 332, which may be floppy disk drives 236 or CD-ROM drives 234 shown in FIG. 2, or any other mass storage device(s), including but not limited to hard drives, Digital Video Disk (DVD) drives, tape drives, etc. Administrative computer 102 has access to remote disk Java applets 334, which tell bootable computer 106 how many MSDs are available to bootable computer 106.

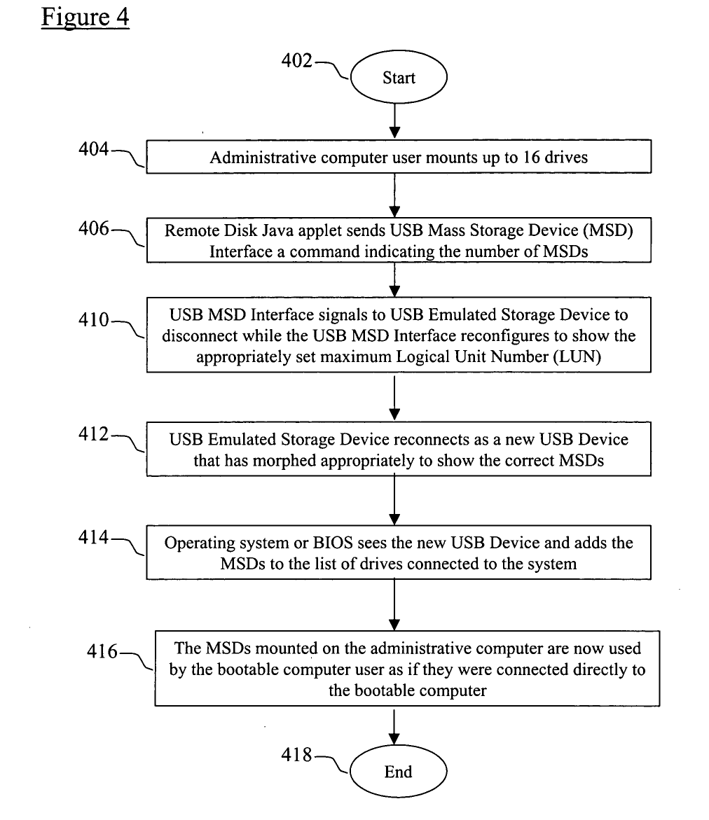

Referring now to FIG. 4, there is illustrated a flow-chart describing a preferred embodiment of the present invention. After starting at initiator block 402, an administrative computer user mounts up to 16 MSDs (drives) on the administrative computer (block 404). These drives are those that will be available to a remote server computer, which will “see” the drives in a local emulated form.

As shown at block 406, the administrative computer then invokes a remote disk Java applet, which sends a command to the USB-MSDI a command indicating how many MSDs are mounted and available to the bootable computer. The USB-MSDI then signals the USB Storage Device Emulator to disconnect from the bootable computer while the USB-MSDI is reconfigured with the appropriate number of mass storage devices according to the maximum Logical Unit Number (block 410). The USB Storage Device Emulator then reconnects (block 412) to the bootable computer, with the USB Storage Device Emulator now presenting the correct number of emulated MSDs. The operating system of the bootable computer “sees” the newly morphed USB Storage Device Emulator (block 414), and adds the MSDs to a list showing the drives connected to the bootable computer. Thus, as shown at block 416, the MSDs mounted on the remote administrative computer are now used by the bootable computer as if the MSDs were mounted directly on the remote bootable computer. The process then ends at terminator 418.

Note that the exemplary embodiments shown in FIGS. 2 and 3 are provided solely for the purposes of explaining the invention and those skilled in the art will recognize that numerous variations are possible, both in form and function. All such variations are believed to be within the spirit and scope of the present invention.

The present invention has been described in relation to particular embodiments that are intended in all respects to be illustrative rather than restrictive. Alternative embodiments will become apparent to those skilled in the art to which the present invention pertains without departing from its spirit and scope. Accordingly, the scope of the present invention is defined by the appended claims rather than the foregoing discussion.

1. A method comprising:
mounting on a first computer a required number of mass storage devices needed by a second computer;
coupling the required number of mass storage devices to a storage device emulator that is coupled to the second computer, the mass storage devices being remotely coupled to the storage device emulator via a network;
dynamically emulating the required number of mass storage devices in the storage device emulator; and
booting the second computer utilizing the emulated mass storage devices in the storage device emulator.

2. The method of claim 1, further comprising:
assigning a logical unit number to each of the mass storage devices, wherein the storage device emulator communicates with each of the mass storage devices by identifying the logical unit number of the mass storage device being utilized.

3. The method of claim 1, wherein the storage device emulator communicates with the required number of mass storage devices by wrapping a Universal Serial Bus (USB) protocol data from the second computer in a Transmission Control Protocol/Internet Protocol (TCP/IP) packet.

4. The method of claim 1, wherein each mass storage device is a USB device.

5. The method of claim 4, wherein at least one of the mass storage devices is a floppy disk drive.

6. The method of claim 4, wherein at least one of the mass storage devices is a Compact Disk-Read Only Memory (CD-ROM) drive.

7. The method of claim 1, wherein the network coupling the mass storage devices with the storage device emulator is a secure administration network.

8. A system comprising:
a first computer;
a second computer coupled to the first computer via a network;
a required number of mass storage devices, needed by the second computer, mounted on the first computer;
a storage device emulator coupled to the required number of mass storage devices and the second computer, the mass storage devices being remotely coupled to the storage device emulator via the network;
means for dynamically emulating the required number of mass storage devices in the storage device emulator; and
means for booting the second computer utilizing the emulated mass storage devices in the storage device emulator.

9. The system of claim 8, further comprising:
means for assigning a logical unit number to each of the mass storage devices, wherein the storage device emulator communicates with each of the mass storage devices by identifying the logical unit number of the mass storage device being utilized.

10. The system of claim 8, wherein the storage device emulator communicates with the required number of mass storage devices by wrapping a Universal Serial Bus (USB) protocol data from the second computer in a Transmission Control Protocol/Internet Protocol (TCP/IP) packet.

11. The system of claim 8, wherein each mass storage device is a USB device.

12. The system of claim 11, wherein at least one of the mass storage devices is a floppy disk drive.

13. The system of claim 11, wherein at least one of the mass storage devices is a Compact Disk-Read Only Memory (CD-ROM) drive.

14. The system of claim 8, wherein the network coupling the mass storage devices with the storage device emulator is a secure administration network.

15. A computer program product residing on a computer usable medium, the computer program product comprising:
program code for enabling a mounting on a first computer of a required number of mass storage devices needed by a second computer;
program code for coupling the required number of mass storage devices to a storage device emulator that is coupled to the second computer, the mass storage devices being remotely coupled to the storage device emulator via a network;
program code for dynamically emulating the required number of mass-storage devices in the storage device emulator; and
program code for booting the second computer utilizing the emulated mass storage devices in the storage device emulator.

16. The computer program product of claim 15, further comprising:
program code for assigning a logical unit number to each of the mass storage devices, wherein the storage device emulator communicates with each of the mass storage devices by identifying the logical unit number of the mass storage device being utilized.

17. The computer program product of claim 15, wherein the storage device emulator communicates with the required number of mass storage devices by wrapping a Universal Serial Bus (USB) protocol data from the second computer in a Transmission Control Protocol/Internet Protocol (TCP/IP) packet.

18. The computer program product of claim 15, wherein each mass storage device is a USB device.

19. The computer program product of claim 18, wherein at least one of the mass storage devices is a floppy disk drive

20. The computer program product of claim 15 wherein the network coupling the mass storage devices with the storage device emulator is a secure administration network.

21. A method comprising:
mounting a plurality of mass storage devices on an administrative computer;
presenting to a USB Mass Storage Device Interface on a remote bootable computer a command indicating how many mass storage devices are mounted on the administrative computer and are available for use by the remote bootable computer;
disconnecting a USB Storage Device Emulator from the remote bootable computer while the USB Mass Storage Device Interface is reconfigured to show how many storage devices are mounted on the administrative computer and are available for use by the remote bootable computer; and
reconnecting the USB Storage Device Emulator to the remote bootable computer with the reconfigured USB Mass Storage Device Interface.
